(19) United States
(12) Patent Application Publication
(10) Pub. No.: US 2026/0261754 A1
(43) Pub. Date: Sep. 3, 2026

(54) SYSTEMS AND METHODS FOR CAPTURING DRIVER-RELEVANT ROAD SCENE INFORMATION

(71) Applicant: Toyota Motor Engineering & Manufacturing North America, Inc., Plano, TX (US)

(72) Inventor: Benjamin Piya Austin, Saline, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 19/069,059

(22) Filed: Mar. 3, 2025

(51) Int. Cl. H04N 23/611; G01C 21/34; G06T 7/70; G06V 20/56; G06V 20/59; H04N 23/66

(52) U.S. Cl. CPC H04N 23/611; G01C 21/3453; G06T 7/70; G06V 20/56; G06V 20/597; H04N 23/66; G06T 2207/30201; G06T 2207/30268

(57) ABSTRACT

Methods, systems, and devices for capturing driver-relevant road scene information. The method may include determining driver-relevant road scene information to capture surrounding a vehicle. The method may further include identifying the driver-relevant road scene information in an area surrounding the vehicle. The method may further include after identifying the driver-relevant road scene information, adjusting an external camera coupled to the vehicle to capture a plurality of images of the driver-relevant road scene information in the area surrounding the vehicle. The method may further include receiving, from the external camera, a plurality of images depicting the driver-relevant road scene information. The method may further include storing the plurality of images in a memory of a mobile device, the mobile device being separate from the external camera.

### BACKGROUND

### 1. Field

The present disclosure relates to systems and methods for capturing driver-relevant road scene information around a vehicle.

### 2. Description of the Related Art

Various technologies related to capturing images of the area surrounding a vehicle have been adapted. Existing technologies have included external cameras coupled to the vehicle that can generally capture the area surrounding the vehicle. However, if a driver wishes to capture an image of a particular area surrounding the vehicle, the driver must use their own device (e.g., cell phone) to capture the image. In this way, the driver is at risk of distraction from the primary task of driving.

Accordingly, there is a need to better capture road scene information or driver-relevant images of the surrounding area of the vehicle.

### SUMMARY

Described herein is a method for capturing driver-relevant road scene information. The method may include determining driver-relevant road scene information to capture surrounding a vehicle. The method may further include identifying the driver-relevant road scene information in an area surrounding the vehicle. The method may further include after identifying the driver-relevant road scene information, adjusting an external camera coupled to the vehicle to capture a plurality of images of the driver-relevant road scene information in the area surrounding the vehicle. The method may further include receiving, from the external camera, a plurality of images depicting the driver-relevant road scene information. The method may further include storing the plurality of images in a memory of a mobile device, the mobile device being separate from the external camera.

In one aspect, the subject matter may be embodied in a system for capturing driver-relevant road scene information or images around a vehicle. In one aspect, the system includes an internal camera configured to detect a position of a head or an eye of the driver and an external camera configured to detect image data from around the vehicle. The system also includes an electronic control unit (ECU) configured to (1) receive an indication from the driver to capture an image of driver-relevant road scene information in an area surrounding the vehicle, (2) determine, from the internal camera, the position or view of a head or eyes of the driver of the vehicle, (3) adjust, based on the position or view of the head or the eyes of the driver and the indication from the driver, the external camera to capture a plurality of images of the driver-relevant road scene information in the area surrounding the vehicle, (4) receive, from the external camera, a plurality of images depicting the driver-relevant road scene information, and (5) store the plurality of images in a mobile device, the mobile device being separate from the external camera.

In one aspect, the subject matter may be embodied in a vehicle including a system for capturing driver-relevant road scene information. The vehicle may include an external camera configured to detect image data from around or outside the vehicle. The vehicle may further include an ECU configured to (1) receive an indication from the driver to capture an image of driver-relevant road scene information in an area surrounding the vehicle, (2) adjust, based on the indication from the driver, the external camera to capture a plurality of images of the driver-relevant road scene information in the area surrounding the vehicle, (3) receive, from the external camera, a plurality of images depicting the driver-relevant road scene information in the area surrounding the vehicle, and (4) store the plurality of images in a mobile device, the mobile device being separate from the external camera.

### BRIEF DESCRIPTION OF THE DRAWINGS

Other systems, methods, features, and advantages of the present disclosure will be apparent to one skilled in the art upon examination of the following figures and detailed description. Component parts shown in the drawings are not necessarily to scale and may be exaggerated to better illustrate the important features of the present disclosure. In the drawings, like reference numerals designate like parts throughout the different views.

FIG. 1 is a block diagram illustrating a vehicle having a system for capturing driver-relevant road scene information around a vehicle according to an aspect of the disclosure.

FIG. 2 is a view of an example interior of a vehicle including the system for capturing driver-relevant road scene information according to an aspect of the disclosure.

FIG. 3 is an example illustration of a vehicle in operation along a road implementing the system for capturing driver-relevant road scene information according to an aspect of the disclosure.

FIG. 4 is a flowchart illustrating a method for capturing driver-relevant road scene information according to an aspect of the disclosure.

### DETAILED DESCRIPTION

Disclosed herein are systems and/or methods for capturing driver-relevant road scene information or images from an area surrounding a vehicle. The systems and methods described herein may receive an indication from a driver or based on the driver's data to capture road scene information or images of a particular object or surrounding area outside the vehicle. Based on the indication, the systems and methods described herein can capture images of the specified area, object or scenery surrounding (or at a distance from) the vehicle. The systems and methods described herein may include one or more internal cameras to determine the position of the head or the eye(s) of the driver to identify the driver's line of sight and accordingly, the area outside the vehicle that the driver wishes to capture.

Based on the identified line of sight of the driver, one or more external cameras may be adjusted and focused to capture images of the desired area, object or scenery for the driver. The systems and methods described herein may also include a computer, a processor or an electronic control unit (ECU) that can receive the indication to capture images of the area surrounding the vehicle, adjust and/or focus the camera to capture the images of the surrounding area, and store the captured images in memory. The captured images may be stored in a memory of a mobile device for the driver to access at a later point in time so that the driver can focus on the task of driving.

Particular aspects of the subject matter described herein may be implemented to realize one or more of the following advantages. These systems and methods provide various benefits and advantages such as improving safety of driving a vehicle by allowing a driver to focus on the task of driving instead of on capturing images of a surrounding area of a vehicle. Visual distraction from the primary driving task can lead to road incidents. However, sometimes the non-driving-related visual stimuli are important or relevant to the driver to be looked at, even if their priority is less than that of the driving task. For example, the driver in heavy traffic may see a billboard advertisement for a product they are looking for out of the corner of their eye. The driver cannot look at the billboard because they need to keep their eye on the road and dedicated to supporting the driving task. There currently does not exist a system and methods to capture an image of the object or areas of interest outside a moving vehicle and provide that information to the driver at a later time. The present system and method may allow the driver to keep their eyes on the road, especially during challenging driving scenarios, and access the stored images at a later time when it is safe to look at the images. In some aspects, the images may have GPS coordinates attached to them (e.g., if the driver sees a yard sale or store of interest), and the driver can later ask the system to navigate back to the GPS coordinates associated with the image. By providing images of the object or area of interest, along with GPS coordinates, the present system can save the driver time as they no longer have to spend time searching for the location or related information for the area, object or scenery of interest.

The present system can also assist the driver with improving their health outcomes by linking into the driver's health records. For example, integrating with the smart phone containing the driver's health records, the system may see that that the driver received a note from his doctor saying, “You need to get out to walk at least twice every day.” The system can interpret this message and automatically look for areas where pedestrians are walking over the course of the drive. In examples, at the end of the drive, the system can render a heat map for the driver showing the areas on the map where pedestrians were present. The pedestrian-density map may show the driver, as an example, “Here's where you will want to walk if you want to be among people; otherwise, walk in these areas if you seek to walk alone.” Therefore, the present system can encourage and help the driver to improve their health outcomes.

An exemplary system for capturing driver-relevant road scene information or images around a vehicle is disclosed herein. The system includes an internal camera configured to detect a position of a head or an eye(s) of the driver and an external camera configured to detect image data from around or outside the vehicle. The system may also include an electronic control unit (ECU) configured to (1) receive an indication from the driver to capture an image of driver-relevant road scene information in an area surrounding the vehicle, (2) determine, from the internal camera, the position or view of a head or eyes of the driver of the vehicle, (3) adjust and/or focus, based on the position or view of the head or the eyes of the driver and the indication from the driver, the external camera to capture a plurality of images of the driver-relevant road scene information in the area surrounding the vehicle, (4) receive, from the external camera, a plurality of images depicting the driver-relevant road scene information, and (5) store the plurality of images in a mobile device, the mobile device being separate from the external camera. The external camera may be located or positioned on the outside surface of the vehicle. As an example, the one or more external cameras can be located or positioned on an outside surface of the vehicle such that the external cameras may capture images of the surrounding area of the vehicle.

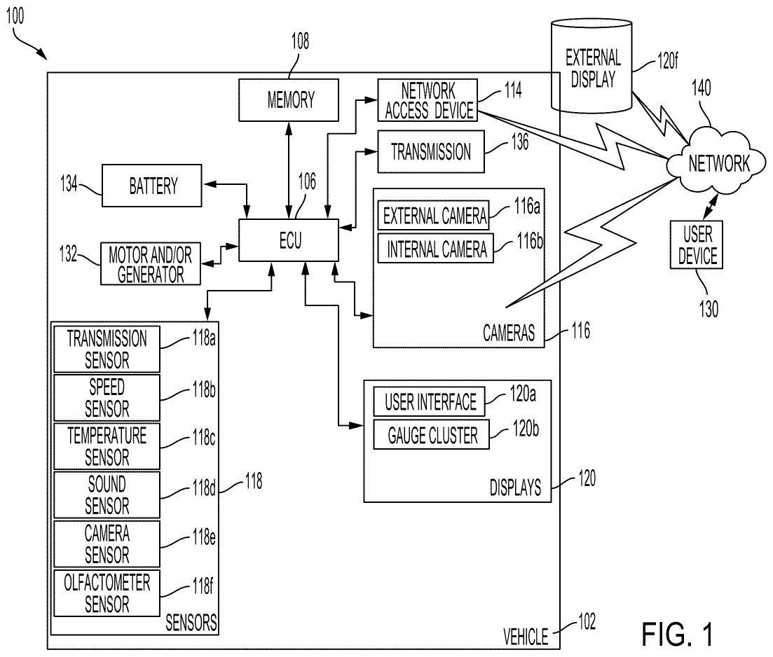

Turning to FIG. 1, a driver-relevant scene capturing system 100 is illustrated. The driver-relevant scene capturing system 100 or a portion thereof may be retrofitted, coupled to, include, or be included within a vehicle 102 or separate from the vehicle 102. The vehicle 102 may be a conveyance capable of transporting a person, an object, or a permanently or temporarily affixed apparatus. The vehicle 102 may be a self-propelled wheeled conveyance, such as a car, a sports utility vehicle, a truck, a bus, a van or other motor, battery or fuel cell driven vehicle. For example, the vehicle 102 may be an electric vehicle, a hybrid vehicle, a hydrogen fuel cell vehicle, a plug-in hybrid vehicle or any other type of vehicle that has a fuel cell stack, a motor, an engine, and/or a generator. Other examples of vehicles include bicycles, trains, planes, or boats, and any other form of conveyance that is capable of transportation. The vehicle 102 may be semi-autonomous or autonomous. That is, the vehicle 102 may be self-maneuvering and navigate without human input. An autonomous vehicle may have and use one or more sensors and/or a navigation unit to drive autonomously.

The driver-relevant scene capturing system 100 may include one or more processors, such as an electronic control unit (ECU) 106. The ECU 106 may be implemented as a single ECU or as multiple ECUs. The ECU 106 may be electrically connected to some or all of the components of the vehicle 102 and/or the driver-relevant scene capturing system 100 (e.g., via a network 140, such as a controller area network (CAN) bus and/or other protocols). The ECU 106 may be electrically connected to one or more cameras 116, one or more sensors 118, one or more displays 120, a memory 108, and/or a network access device 114. The ECU 106 may include one or more processors (or controllers) specifically designed for controlling operations of the vehicle 102, such as accelerating, braking, controlling a panoramic view monitor (PVM) of the vehicle 102 (e.g., the one or more cameras 116), etc. In examples, the ECU 106 may be and/or include an advanced driver assistance systems (ADAS) sensor fusion ECU, a panoramic view monitor (PVM) ECU, an engine control module (ECM), a transmission control module (TCM), a telematics control unit (TCU), an in-vehicle infotainment (IVI) ECU, a graphics processing unit (GPU), and/or an artificial intelligence (AI) unit.

The network access device 114 may transmit data to and receive data from a user device 130 (e.g., a smart phone, a tablet, a personal computer, etc.) located remotely from the vehicle 102. The driver-relevant scene capturing system 100 may display one or more notifications on the user device 130, similar to user interface 120a. Accordingly, the user device 130 can have a user interface whereby a user can communicate with the ECU 106 from a remote location.

As mentioned above, the vehicle 102 may include one or more cameras 116. The one or more cameras 116 may include an external camera 116a and/or an internal camera 116b. As an example, the external camera 116a may be positioned on the outside surface of the vehicle 102 and the internal camera 116b may be positioned on or near the dashboard, the center console, the head unit, the speedometer, the driver's sun visor, the vehicle a-beam, etc.

The one or more cameras 116 may be a digital camera, an infrared thermal camera, and/or a night vision camera (e.g., utilizing active illumination and/or image intensification). In examples, the one or more cameras 116 may be and/or include a panoramic view monitor (PVM) system of the vehicle 102. The one or more cameras 116 may provide, capture, and/or record real-time video (or video data) including images and/or video of a surrounding area of the vehicle 102 and/or inside the vehicle 102. Each camera of the one or more cameras 116 may capture one or more fields of view that may include at least a portion of the surrounding area, inside the vehicle 102, and/or outside the vehicle 102. In examples, each camera of the one or more cameras 116 may allow the user to change a zoom level of each camera (e.g., via a user interface 120a) and/or the vehicle 102 may automatically change the zoom level of each camera based on a speed of the vehicle 102 (e.g., the zoom level decreases as the speed of the vehicle 102 increases).

The external camera 116a may include one or more cameras that are positioned on the outside surface of the vehicle 102, and/or a side of the vehicle (e.g., a side quarter panel, a side door, etc.). In examples, the vehicle 102 may include a plurality of external cameras each having a different field of view and/or orientation. The external camera 116a may provide, capture, and/or record real-time video of a field of view (or direction) with respect to the vehicle 102 (e.g., capturing a portion of the surrounding area that is to the left front and/or right front of the vehicle 102 and/or capturing a portion of the left side and/or right side of the vehicle).

The internal camera 116b may be positioned on the interior of the vehicle, such as the interior of a left A-beam and/or a right A-beam, and/or a dashboard of the vehicle 102. In examples, the vehicle 102 may include a plurality of internal cameras each having a different field of view and/or orientation. The internal camera 116b may provide, capture, and/or record real-time video of an interior field of view (or direction) with respect to the vehicle 102 (e.g., capturing a portion of the area that is inside of the vehicle 102 including the passengers inside the vehicle).

In examples, the internal camera 116b may be used to capture images of a person inside the vehicle 102. The images of the person captured by the internal camera 116b may be used by the ECU 106 to determine a field of view of the person (e.g., the driver). The internal camera 116b can sense the position of the head of a driver 502 or use eye-tracking to determine the field of view of the person or the direction in which the person is looking. The field of view or direction in which the person is looking may help the system 100 in identifying an area the person wishes to capture outside of the vehicle.

The vehicle 102 may further include one or more sensors (or one or more vehicle sensors) 118. The one or more sensors 118 may include an ECU for each respective sensor, where each ECU may be part of an ECU network. The one or more sensors 118 may be integrated with the vehicle. The one or more sensors 118 may measure, detect (or indicate), and/or determine one or more conditions (or one or more vehicle conditions) of the vehicle 102 periodically and/or continuously. The one or more conditions of the vehicle 102 may include a shift position, a vehicle speed, a turn signal status, a steering angle, a camera condition, a GPS location, a sound level around the vehicle 102, a temperature around the vehicle 102, an odor around the vehicle 102, and/or a proximity to one or more objects. The one or more sensors 118 may be and/or include software, hardware, firmware, or a combination thereof for measuring, detecting, and/or determining the one or more conditions of the vehicle 102. The one or more sensors 118 may include a transmission sensor (or shift sensor) 118a, a speed sensor 118b, a temperature sensor 118c, a sound sensor 118d, a camera sensor 118e, and/or one or more olfactometer sensors 118f. In examples, the vehicle 102 may include two or more, three or more, four or more, or all of the transmission sensor 118a, the speed sensor 118b, the temperature sensor 118c, the sound sensor 118d, the camera sensor 118e, and/or the one or more olfactometer sensors 118f.

The transmission sensor 118a may be located within the vehicle 102 and/or coupled to the transmission 136 of the vehicle 102. The transmission sensor 118a may indicate, detect, and/or determine the shift position (or gear position or mode) of the vehicle 102 and/or the transmission 136. The shift position may include drive, reverse, and/or neutral or ON for battery operated vehicles. In examples, the vehicle 102 may include a plurality of transmission sensors.

The speed sensor 118b may be located within the vehicle 102. The speed sensor 118b may measure, detect, and/or determine the vehicle speed of the vehicle 102. In examples, the speed sensor 118b may measure, detect, and/or determine the vehicle speed based on a rotation speed of an output shaft of the transmission 136, a rotation speed of the one or more wheels of the vehicle 102, and/or a global positioning system (GPS) signal. In examples, the vehicle 102 may include a plurality of speed sensors.

The temperature sensor 118c may be located within the vehicle 102 and/or coupled to the exterior of the vehicle 102. The temperature sensor 118c may measure, detect, and/or determine a temperature of the air in and/or outside of the vehicle 102.

The sound sensor 118d may be located within the vehicle 102 and/or coupled to the exterior of the vehicle 102. The sound sensor 118d may measure, detect, and/or determine the sound in the area inside or surrounding the vehicle 102. In examples, the vehicle 102 may include a plurality of sound sensors. The sound sensor 118d may be a type of microphone or other device capable of measuring sound in the environment inside or surrounding the vehicle 102.

The camera sensor 118e may be located within the vehicle 102. The camera sensor 118e may indicate, detect, and/or determine the camera condition of the vehicle 102. For example, the camera condition may include whether the external camera 116a and/or internal camera 116b is activated.

The one or more olfactometer sensors 118f may be coupled to the exterior of the vehicle 102. The one or more olfactometer sensors 118f may measure, detect, and/or determine the odors in the surrounding area of the vehicle 102. The one or more olfactometer sensors 118f may measure, detect, and/or determine an odor detection threshold of substances and/or intensity of odors in the surrounding area of the vehicle 102.

The driver-relevant scene capturing system 100 may further include one or more displays 120. The one or more displays 120 may include a user interface (or infotainment display) 120a and/or a gauge cluster 120b. The one or more displays 120 may be native to the vehicle 102 and/or may be retrofitted to the vehicle 102. The one or more displays 120 may include a liquid crystal display (LCD), a light-emitting diode (LED) display, a segment display, a holographic display, an e-paper display, a laser color video display, and/or other display types. In examples, the one or more displays 120 may include an external display (e.g., a mobile phone, a laptop, a tablet, etc.) that may have some or all of the functions (e.g., receiving and displaying images) as the user interface 120a and/or the gauge cluster 120b.

The user interface 120a may be located within the cabin of the vehicle 102 and/or may be coupled to a dashboard of the vehicle 102. The user interface 120a may provide an interface to the user of the vehicle 102 to interact with and/or receive output from the ECU 106. The user interface 120a may have a user interface element, such as one or more screens and/or one or more touchscreens with a button, a switch, a microphone, a speaker, a gesture monitoring sensor, a knob, a graphical user interface (GUI), and/or other input/output devices electrically connected to the ECU 106 to provide input and/or output of information (or data) to and/or from the ECU 106.

The gauge cluster 120b may be located within the cabin of the vehicle 102 and/or may be coupled to the dashboard of the vehicle 102. The gauge cluster 120b may have one or more screens and/or physical indicators to display vehicle information such as a speedometer, a tachometer, an energy and/or fuel level indicator, a map, etc.

The ECU 106 may receive real-time video data from the one or more cameras 116 including the external camera 116a and/or the internal camera 116b. The ECU 106 may determine, via the internal camera 116b, a position of the head of the driver. The ECU 106 may control and/or activate the external camera 116a to capture real-time video data including the surrounding view of the vehicle. The ECU 106 may cause the external camera 116a to adjust its position to capture a plurality of images of surrounding view of the vehicle. The external camera 116a may not need to be moved or adjusted when the external camera 116a has a wide field of view. The ECU 106 may receive, from the external camera 116a, a plurality of images depicting the surrounding area of the vehicle.

Based on the received images from the external camera 116a, the ECU 106 may save the images to memory so that the driver can access the images at a later point in time. The ECU 106 may optionally crop the received images (e.g., via intelligent cropping) where the field of view of the camera 116a is wider than the area the driver wished to capture.

The vehicle 102 may include a motor and/or generator 132, a battery 134, and/or a transmission 136. The motor and/or generator 132 may be located within an engine bay of the vehicle 102. The motor and/or generator 132 may be an internal combustion engine (ICE). In this regard, the motor and/or generator 132 may combust an air and fuel mixture to provide power to the vehicle 102 and/or components of the vehicle 102. Accordingly, the motor and/or generator 132 can cause the vehicle 102 to accelerate, decelerate, or maintain a desired velocity. The motor and/or generator 132 may include combinations of an ICE and an electric motor, such as for hybrid vehicle applications, for example. In examples, the motor and/or generator 132 may be an electric motor. In this regard, the motor and/or generator 132 may be an electric motor and an electric generator that converts electrical energy into mechanical power, such as torque, and converts mechanical power into electrical energy. The motor and/or generator 132 may be electrically connected to the battery 134. The motor and/or generator 132 may convert energy from the battery 134 into mechanical power, and may provide energy back to the battery 134, for example, via regenerative braking. The battery 134 may be electrically connected to the motor and/or generator 132 and may provide electrical energy to and/or receive electrical energy from the motor and/or generator 132. The battery 134 may provide electrical energy to the vehicle 102.

The transmission 136 may be an automatic transmission (e.g., a 6-speed, 7-speed, 8-speed, 9-speed, or 10-speed automatic transmission) or a manual transmission (e.g., a six-speed manual transmission) having at least one reverse gear, a neutral position, and at least one forward (or drive) gear. In examples, the transmission 136 may be an electric vehicle transmission (e.g., a single speed or two speed transmission). The transmission 136 may receive torque from the motor and/or generator 132 and may transfer the torque to one or more wheels of the vehicle 102.

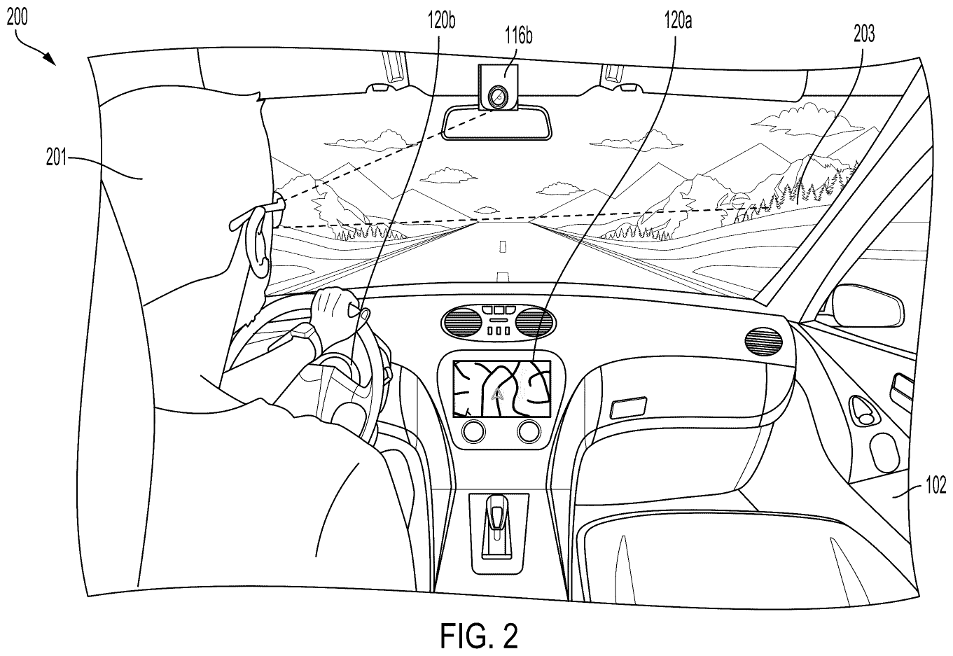

FIG. 2 is an illustration 200 of an example interior of the vehicle 102 that may incorporate the example driver-relevant scene capturing system 100 of FIG. 1. The interior of the vehicle 102 may include one or more internal cameras 116b, a user interface (or infotainment display) 120a and/or a gauge cluster 120b. Within the interior of the vehicle 102 may be a driver 201, who is operating the vehicle. Outside the vehicle 102, may be objects or a scene surrounding the vehicle 102 that may include driver-relevant road scene information. For example, outside the vehicle 102 next to the road may be a group of trees 203 that may be of interest to the driver 201.

The internal cameras 116b may be positioned on the dashboard, mirrors, pillars, or otherwise placed within the interior of the vehicle 102. The internal cameras 116b may capture images of the driver 201. In examples, the internal cameras 116b may detect a position of the head and/or eyes of a driver 201. In some aspects, infrared light sources in the form of flood projection in the cabin of the vehicle 102 can also be used to determine the position of the head of the driver 201 in dark situations and the like. The images detected by the internal cameras may be passed to a controller (e.g., ECU 106 of FIG. 1) that can determine, based on the detected position of the head of the driver 201, where the field of view for the driver 201 is and, correspondingly, what the driver 201 may be looking at outside the vehicle 102. For example, based on images from the internal cameras 116b, the ECU 106 can determine from the position of the driver 201's head or eye position that the driver 201 may be looking towards the group of trees 203 on the side of the road.

In some aspects, the driver-relevant scene capturing system 100 may use existing eye tracker or imaging technology to identify a driving scene or point of interest initiated by the driver. The driver-relevant scene capturing system 100 can then take a picture of what the driver glances at using existing vehicle cameras.

The driver 201 may indicate that they wish the driver-relevant scene capturing system 100 to capture an image of something along the road (e.g., the group of trees 203). For example, the driver 201 may give the vehicle 102 an auditory command or press a button to indicate they wish the driver-relevant scene capturing system 100 to capture the image(s). In some aspects, the driver may use programmed commands or auditory commands to initiate the capturing of images of the area surrounding the vehicle. For example, the driver may tell the vehicle: “If you see any classic cars around me, please take a picture” or “Please take a picture of that billboard.” In some aspects, the driver may press a button (e.g., on the vehicle steering wheel) to trigger the driver-relevant scene capturing system 100 to capture images of the area surrounding the vehicle.

In examples, the driver-relevant scene capturing system 100 may detect driver-relevant information along the road and alert the driver (e.g., via the user interface 120a and/or gauge cluster 120b) about the driver-relevant information and/or prompt the driver to adjust navigation based on the driver-relevant information.

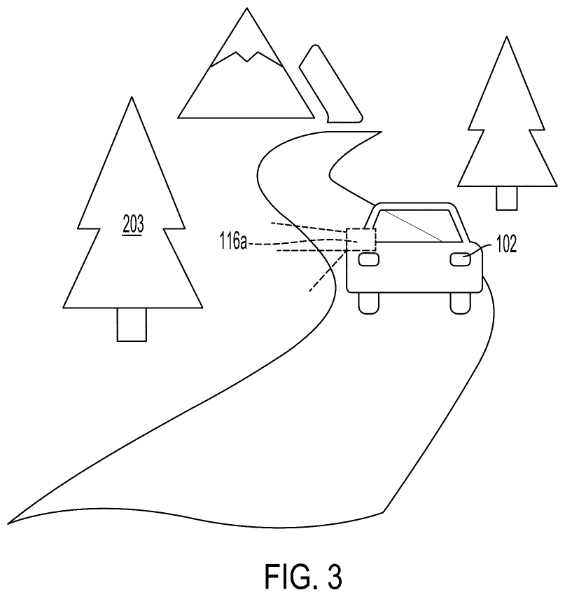

FIG. 3 is an example illustration of a vehicle 102 in motion along a roadway implementing the system for capturing driver-relevant road scene information according to an aspect of the disclosure. The vehicle 102 may include an external camera 116a and/or one or more sensors 118. The external camera 116a may be positioned on the outside surface of the vehicle 102, and/or a side of the vehicle (e.g., a side quarter panel, a side door, etc.), such that the external camera 116a may capture an area surrounding the vehicle 102. The vehicle 102 may also include one or more internal cameras (not shown), such as the internal camera 116b as shown and described in FIG. 2.

The external camera 116a may be adjusted to capture driver-relevant road scene information. In some aspects, the external camera 116a may be adjusted based on the determined position of the driver 201 in order to properly capture images in this particular driver's line of sight. For example, the external camera 116a may be rotated and/or moved towards the direction of the driver's line of sign. In other aspects, the external camera 116a may be adjusted based on a command or a request from the driver. For example, the external camera 116a may be adjusted based on the driver's command to take a picture of a billboard along the side of the road. The images captured by the external camera 116a may be sent (e.g., via the ECU 106) to be stored in a memory so that the driver may access the images at a later time and/or date. Furthermore, although described herein as capturing images based on the driver's point of view, the driver-relevant scene capturing system 100 may also be configured to capture images based on another passenger's point of view and/or commands.

In some aspects, the driver-relevant scene capturing system 100 can also link into the driver's health records. The driver-relevant scene capturing system 100 may be integrated and/or linked with a device (e.g., user device 130 of FIG. 1) that includes and/or stores the driver's health records. The driver-relevant scene capturing system 100 can access the driver's health records via the device. Health records may include health information such as doctor notes, vital signs, lab results, and the like. Based on the information in the driver's health records, the driver-relevant scene capturing system 100 can identify areas surrounding the vehicle that may be relevant to the driver.

For example, integrating with the smart phone containing the driver's health records, the driver-relevant scene capturing system 100 may see that that the driver received a note from his doctor saying, “You need to get out to walk at least twice every day.” The driver-relevant scene capturing system 100 can interpret this message (e.g., via the ECU 106) and automatically look for areas where pedestrians are walking over the course of a drive. In examples, at the end of the drive, the driver-relevant scene capturing system 100 can render (e.g., via the ECU 106) a heat map for the driver showing the areas on the map where pedestrians were present. The pedestrian-density map may show the driver, as an example, “Here's where you will want to walk if you want to be among people; otherwise, walk in these areas if you seek to walk alone.”

In another example, the driver-relevant scene capturing system 100 may see there is a note from the driver's doctor saying, “You need to do low impact exercises like swimming.” Similarly to the walking example, the driver-relevant scene capturing system 100 may recognize a public pool or advertisement for a pool along the driver's route and capture images of the public pools or advertisements related to pools.

The driver-relevant scene capturing system 100 may also capture environmental factors (e.g., via the vehicle's sensors 118) in the area surrounding the vehicle based on the driver's needs. For instance, the driver-relevant scene capturing system 100 may capture environmental factors based on the driver's health records. In one example, the driver-relevant scene capturing system 100 may determine from the driver's health records that the driver has had recent hearing damage (e.g., in the driver's health records, the doctor may have put into the driver's appointment summary, “You need to stay away from loud environments.”). Therefore, as the vehicle is driving, the driver-relevant scene capturing system 100 may identify areas that have a potential for loud noise, such as a sign indicating a construction area ahead, and/or identify loud areas via the sound sensor 118d. Given the loud nature of construction areas, the driver-relevant scene capturing system 100 can suggest avoiding the loud area. For example, the driver-relevant scene capturing system 100 can send an alert to the driver via the vehicle displays 120 or prompt the vehicle 102 to self-drive via a route that avoids the construction.

Similarly, the driver-relevant scene capturing system 100 can detect objects (e.g., via the external cameras 116a) like a crane, a dump truck, road construction signs or markers, etc. that may indicate there is construction on the road taking place and alert the driver that they may want to choose a different route or self-drive the vehicle to a route that avoids the construction. In another example, the driver-relevant scene capturing system 100 may use auditory sensors to detect the sound level in the area surrounding the vehicle and alert the driver and/or redirect the vehicle. In another example, the driver-relevant scene capturing system 100 may use images to determine that many of the buildings surrounding the vehicle 102 are made of glass and there are no trees surrounding the vehicle and therefore, the vehicle 102 may be in an area which may not absorb sound well. So, the driver-relevant scene capturing system 100 can alert the driver or may redirect the vehicle 102 to a more residential area or green area that can better absorb sound.

In some aspects, the vehicle 102 may include an olfactometer sensor 118f that can detect smells in the environment surrounding the vehicle 102. Therefore, if the driver has chemical sensitivity (e.g., natural gas, perfumes/colognes that are synthetic) as shown by the driver's health records, the driver-relevant scene capturing system 100 may identify an odor surrounding the vehicle 102 via the olfactometer sensor 118f and prompt the driver to seek alternate routes or otherwise redirect a self-driving vehicle to an alternate route.

In another example, the driver-relevant scene capturing system 100 can determine from the driver's health records that the driver just had their eyes dilated and needs to avoid bright scenes. In this case, a vehicle navigation system may use topographical maps or other online maps images of the driving route to identify routes that have a lot of tree coverage, shade, and/or shadow. The driver-relevant scene capturing system 100 can therefore route the driver and/or vehicle 102 to those routes identified as being less bright.

In another example, the driver-relevant scene capturing system 100 can determine from the driver's health records that the driver had a recent hip replacement or broken bone. The driver-relevant scene capturing system 100 could avoid routes that have cobblestones or a lot of potholes based on the image data from the vehicle cameras 116 and can try to navigate the vehicle on sleek roads that have the least amount of damage that may cause discomfort to the driver.

In another example, the driver-relevant scene capturing system 100 can determine from the driver's health records that the driver has a sensitivity to heat. The driver-relevant scene capturing system 100 may use the temperature sensor 118c to track the temperature outside the vehicle. Accordingly, the driver-relevant scene capturing system 100 can alert the driver to avoid areas that appear to be an inappropriate temperature based on the detected temperature data.

In some aspects, the driver-relevant scene capturing system 100 can store the environmental factor data for later use. The driver then can access the environmental factor data if they wish or in addition, the driver-relevant scene capturing system 100 may access the environmental factor data to determine future driving routes. For example, if the driver-relevant scene capturing system 100 identified a construction area in a particular area, the vehicle 102 navigation may avoid that area in future driving routes based on the stored data.

In some aspects, driver-relevant scene capturing system 100 may use artificial intelligence or machine learning techniques to determine historical patterns of the driver, along with general data available on the internet (e.g., current weather, news sources, etc.), to find the optimum route for the driver. For instance, these techniques can identity which roads on the driver's route are likely to be slick, such as by accessing weather data online and information about the types of roads along the driving route (e.g., some asphalt may be slicker during precipitation than others). These techniques may also use data from the vehicle 102's sensors or cameras to determine the weather. For example, if the vehicle's sensors or cameras detect it is snowing, the driver-relevant scene capturing system 100 can determine, using artificial intelligence or machine learning techniques, which county or area is better at salting and cleaning the roads than other areas that may be slow to clear the roads or don't clear the roads at all, which could cause hazards and be more likely to have potholes or disguised speed bumps. Based on this, the system can alert the driver to seek alternate routes.

In other aspects, the driver-relevant scene capturing system 100 may integrate with the driver's device (e.g., mobile phone, laptop, etc.), such as user device 130 of FIG. 1, to selectively acquire images estimated to be in alignment with driver interests or needs. The driver-relevant scene capturing system 100 may determine (e.g., via the ECU 106) from the driver's device that the driver is interested in a particular area or object. For example, consider a driver who had previously been searching on the internet for a dual-suspension mountain bike (DSMB). If the driver's device is linked to the driver-relevant scene capturing system 100, the driver-relevant scene capturing system 100 can automatically capture images (e.g., via the external camera 116a) of DSMBs when passed by the vehicle.

Moreover, the driver-relevant scene capturing system 100 can dedicate its plurality of sensors (external cameras 116a, etc.) to take pictures and/or videos of any DSMBs, such that all sensors capture the images from different angles and can recreate and/or render 3D and 4D images for the driver. Thus, images and/or videos of only relevant objects may be captured.

The driver-relevant scene capturing system 100 may also upload the images to a cloud database that can use the 2D/3D/4D images to search for the exact observed DSMB on the internet and provide details to the driver. For example, the details may include who manufactured the object, how much the object costs, where the object can be bought online, and other details of the object (e.g., Manufactured by Trek in 2023, $1500 on Amazon. com, 4.8 stars, comes in red/black/blue, 5-year warranty, etc.). In some aspects, the driver can then order the object (e.g., DSMB) through the infotainment system in their vehicle.

Because the driver-relevant scene capturing system 100 can find information about the object on the internet, the driver-relevant scene capturing system 100 can determine if the object is actually available to the driver. For example, in the DSMB example, the internet search may show that the bike is not made in the driver's size, there exists only a version of the DSMB not suitable for the driver, or the DSMB is no longer being manufactured. If the driver-relevant scene capturing system 100 determines the bike is not available, it may not take pictures and/or videos of the bike, so that it can re-allocate its cameras to viable products.

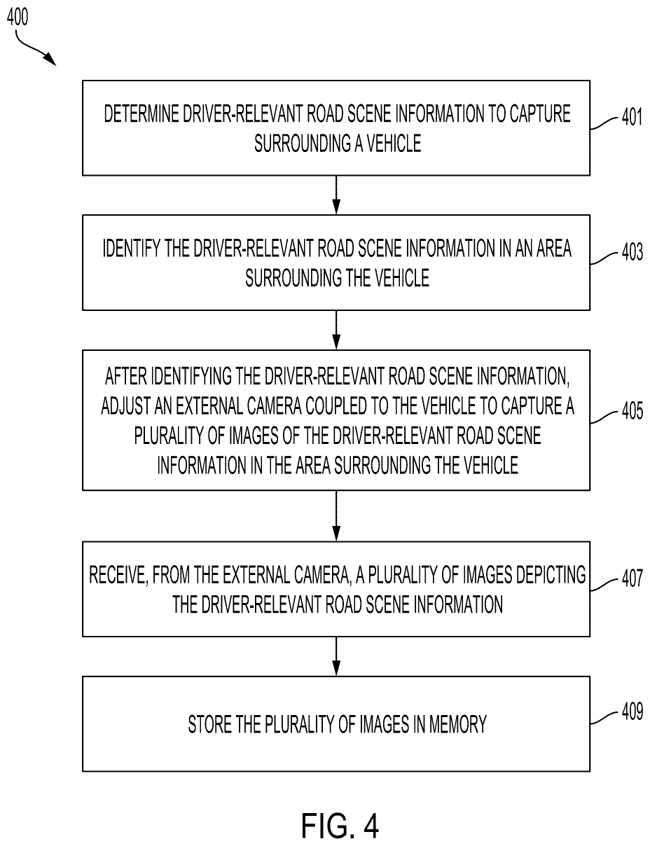

FIG. 4 is a flowchart illustrating a method 400 for capturing driver-relevant road scene information according to an aspect of the disclosure. One or more computers or one or more data processing apparatuses, for example, the ECU 106 of the driver-relevant scene capturing system 100 of FIG. 1, appropriately programmed, may implement the method 400. The method 400 of the disclosure, however, is not limited to use of the exemplary driver-relevant scene capturing systems of FIGS. 1-3.

The method 400 begins at block 401 where the driver-relevant scene capturing system 100 may determine driver-relevant road scene information to capture surrounding a vehicle. In some aspects, in order to determine the driver-relevant road scene information, the driver-relevant scene capturing system 100 may receive an indication from a driver of the vehicle to capture an image of the driver-relevant road scene information and determine, based on the indication, the driver-relevant road scene information. For example, the indication may be an oral command from the driver (“Hey vehicle, take a picture of that billboard!”) or button press (e.g., on the steering wheel) by the driver indicating the driver wishes the driver-relevant scene capturing system 100 to capture an image of the driver-relevant road scene information in the surrounding area of the vehicle.

In some aspects, in order to determine the driver-relevant road scene information, the driver-relevant scene capturing system 100 may determine, from an internal camera coupled to the vehicle, a position or view of a head or eyes of the driver of the vehicle, and adjust, based on the position or view of the head or the eyes of the driver and the indication from the driver, the external camera to capture a plurality of images of the area surrounding the vehicle. For example, the internal camera may determine a position of the driver's head, which may indicate the driver's line of sight and accordingly, the direction the driver is looking. From that position and from the information in the indication from the driver (e.g., (“Hey vehicle, take a picture of that billboard!”), the driver-relevant scene capturing system 100 can adjust the external camera to point towards what the driver is looking at (e.g., the billboard). In some aspects, the internal camera may be positioned inside of the vehicle opposite the driver and may be one or more cameras capable of tracking the eyes of the driver to determine the position of the head of the driver.

In some aspects, the driver-relevant scene capturing system 100 may determine based on image data from inside the vehicle detected by an internal camera (e.g., the internal camera 116b) a position of a head of a driver of a vehicle (102). The driver-relevant scene capturing system 100 may determine the position of the head or the eye of the driver via the ECU 106. The internal camera may be positioned inside the vehicle opposite the driver such that the internal camera can capture the head or the eye of the driver. The image data may show the driver sitting in the vehicle and the height, direction, and angle of the driver's head or eyes. The internal camera may include one or more cameras that are capable of tracking the head and/or eyes of the driver to determine the line of sight of the driver.

In some aspects, in order to determine the driver-relevant road scene information, the driver-relevant scene capturing system 100 may receive health records of the driver of the vehicle and determine driver-relevant road scene information, such as a type of area, object or scene along the driver's route, that may pertain to the health issue. The health records may include information that indicates a health issue associated with the driver. For example, the health records may show that the driver is suffering from an injury or disease. Accordingly, the driver-relevant scene capturing system 100 can determine driver-relevant road scene information that may pertain to that particular injury or disease. Examples of such are described in further detail above with respect to FIG. 3.

In some aspects, in order to determine the driver-relevant road scene information, the driver-relevant scene capturing system 100 may receive device data from a device associated with a driver of the vehicle, and determine, based on the device data, driver-relevant road scene information, such as a type of area, object or scene along a driver's route, that may pertain to the object of interest. The device data may indicate an object of interest of the driver. For example, driver-relevant scene capturing system 100 may receive data from the driver's mobile phone, which includes internet searches for a mountain bike. Accordingly, the driver-relevant scene capturing system 100 can determine a mountain bike may be of interest to the driver to capture along the driver's route. Examples of such are described in further detail above with respect to FIG. 3.

At block 403, the driver-relevant scene capturing system 100 may identify the driver-relevant road scene information in an area surrounding the vehicle. For example, as the vehicle is on the road, the driver-relevant scene capturing system 100 can identify the driver-relevant road scene information (e.g., billboard, mountain bike, etc. as described in the examples above with respect to FIG. 3) along the road.

At block 405, the driver-relevant scene capturing system 100 may, after identifying the driver-relevant road scene information, adjust an external camera coupled to the vehicle to capture a plurality of images of the driver-relevant road scene information in the area surrounding the vehicle. The external camera may adjust its position based on the indication for the driver. For example, if the driver indicates to capture an image of a billboard, then the external camera may adjust its position towards the billboard. The external camera may be positioned outside the vehicle and may be one or more cameras configured to capture real-time video data of one or more fields of view of the surrounding area of the vehicle.

The driver-relevant scene capturing system 100 may adjust and/or focus, based on the position of the head or the eyes of the driver, a position of an external camera (e.g., the external camera 116a) to capture a plurality of images of the driver's line of sight. The external camera may be positioned outside the vehicle 102 and adjacent to or on the external surface of an A-beam or pillar of the vehicle. The camera angle may be adjusted in order to capture images of the driver's field of view. For example, the camera may be adjusted to the right, to the left, up and/or down in order to appropriately capture the area of interest for the driver. The external camera may include one or more cameras that are coupled to the ECU. The external camera may then send the image data to the ECU.

At block 407, the driver-relevant scene capturing system 100 may receive, from the external camera, a plurality of images depicting the driver-relevant road scene information. For example, the plurality of images may be one or more pictures and/or videos of the driver-relevant road scene information as captured along the driving route (e.g., billboard, mountain bike, etc. as described in the examples above with respect to FIG. 3).

The driver-relevant scene capturing system 100 may receive, from the external camera, a plurality of images depicting the driver's line of sight and the driver-relevant road scene information. The external camera may be configured to capture real-time video data of one or more fields of view of a surrounding area of the vehicle 102. For example, the external camera may capture a billboard on the side of the road which may be in the driver's line of sight.

At block 409, the driver-relevant scene capturing system 100 may store the plurality of images in a memory. The memory may be in a mobile device (e.g., user device 130 of FIG. 1) that may be separate from the external camera. For example, the mobile device may be the driver's mobile phone, laptop, desktop, etc. The images may be stored such that the driver (or other authorized person) can access the images after the drive is complete. Therefore, the driver can focus on the task of driving while operating the vehicle and can look at the desired images at a later point in time.

In some aspects, the driver-relevant scene capturing system 100 may further adjust navigation or alert the driver to adjust navigation of the vehicle based on the identified driver-relevant road scene information (e.g., identified construction, loud noise, rough road, etc. as described in the examples above with respect to FIG. 3). For example, in the case of an autonomous or semiautonomous vehicle, the vehicle may change the navigation of the vehicle based on the identified driver-relevant road scene information. In the case of a driver operated vehicle, the driver-relevant scene capturing system 100 may alert the driver (e.g., via the displays 120) that they may wish to choose a different route of navigation based on the identified driver-relevant road scene information.

Exemplary aspects or embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such aspects or embodiments that reasonably fall within the scope of the advancement to the art hereby contributed, and that that scope shall not be restricted, except in light of the appended claims and their equivalents.

1. A method for capturing driver-relevant road scene information, the method comprising:
receiving health records of a driver of a vehicle, the health records indicating a health issue associated with the driver;
determining, based on the health issue, driver-relevant road scene information including a type of area or object along the driver's route that pertains to the health issue;
identifying the driver-relevant road scene information in an area surrounding the vehicle;
after identifying the driver-relevant road scene information, adjusting an external camera coupled to the vehicle to capture a plurality of images of the driver-relevant road scene information in the area surrounding the vehicle;
receiving, from the external camera, a plurality of images depicting the driver-relevant road scene information; and
storing the plurality of images in a memory of a mobile device, the mobile device being separate from the external camera.

2. The method of claim 1, further comprising driver:
receiving an indication from a driver of the vehicle to capture an image of the driver-relevant road scene information; and
determining, based on the indication, the driver-relevant road scene information.

3. The method of claim 2, wherein the indication comprises an oral command from the driver or button press by the driver indicating the driver-relevant road scene information.

4. The method of claim 2, wherein adjusting the external camera is based on the indication from the driver.

5. The method of claim 2, further comprising:
determining, from an internal camera coupled to the vehicle, a position or view of a head or eyes of the driver of the vehicle; and
adjusting, based on the position or view of the head or the eyes of the driver and the indication from the driver, the external camera to capture a plurality of images of the area surrounding the vehicle.

6. The method of claim 5, wherein the internal camera is positioned inside the vehicle opposite the driver and comprises one or more cameras capable of tracking the eyes of the driver to determine the position of the head of the driver.

7. (canceled)

8. The method of claim 1, wherein determining the driver-relevant road scene information comprises:
receiving device data from a device associated with a driver of the vehicle, wherein the device data indicates an object of interest of the driver; and
determining, based on the device data, driver-relevant road scene information comprising a type of area or object along a driver's route that may pertain to the object of interest.

9. The method of claim 1, wherein the external camera is positioned outside the vehicle and comprises one or more cameras configured to capture real-time video data of one or more fields of view of a surrounding area of the vehicle.

10. The method of claim 1, further comprising adjusting navigation of the vehicle based on the identified driver-relevant road scene information.

11. The method of claim 1, further comprising alerting the driver to adjust navigation of the vehicle based on the identified driver-relevant road scene information.

12. A system for capturing driver-relevant road scene information, the system comprising:
an internal camera configured to detect a position of the head or eyes of a driver of a vehicle;
an external camera configured to detect image data from around the vehicle; and
an electronic control unit (ECU) configured to:
receive health records of the driver of the vehicle, the health records indicating a health issue associated with the driver;
receive an indication from the driver to capture an image of driver-relevant road scene information in an area surrounding the vehicle;
determine, from the internal camera, the position or view of a head or eyes of the driver of the vehicle;
determine, based on the health issue and the indication from the driver, driver-relevant road scene information including a type of area or object along the driver's route that pertains to the health issue;
adjust, based on the position or view of the head or the eyes of the driver, the health issue, and the indication from the driver, the external camera to capture a plurality of images of the driver-relevant road scene information in the area surrounding the vehicle;
receive, from the external camera, a plurality of images depicting the driver-relevant road scene information; and
store the plurality of images in a mobile device, the mobile device being separate from the external camera.

13. The system of claim 12, wherein the internal camera is positioned inside the vehicle opposite the driver and comprises one or more cameras capable of tracking the eyes of the driver to determine the position of the head of the driver.

14. The system of claim 12, wherein the external camera is positioned outside the vehicle and comprises one or more cameras coupled to the ECU and configured to capture real-time video data of one or more fields of view of a surrounding area of the vehicle.

15. The system of claim 12, wherein the indication comprises an oral command from the driver or button press by the driver indicating the driver-relevant road scene information.

16. The system of claim 12, further comprising adjusting navigation of the vehicle based on the driver-relevant road scene information.

17. A vehicle including a system for capturing driver-relevant road scene information, the vehicle comprising:
an external camera configured to detect image data from around the vehicle; and
an electronic control unit (ECU) configured to:
receive health records of a driver of the vehicle, the health records indicating a health issue associated with the driver;
adjust, based on the health issue, the external camera to capture a plurality of images of the driver-relevant road scene information including a type of area or object along the driver's route that pertains to the health issue in the area surrounding the vehicle;
receive, from the external camera, a plurality of images depicting the driver-relevant road scene information in the area surrounding the vehicle; and
store the plurality of images in a mobile device, the mobile device being separate from the external camera.

18. The vehicle of claim 17, wherein the ECU is further configured to:
determine, from an internal camera coupled to the vehicle, a position or view of a head or eyes of the driver of the vehicle; and
adjust, based on the position or view of the head or the eyes of the driver, the external camera to capture a plurality of images of the area surrounding the vehicle.

19. The vehicle of claim 17, wherein the ECU is further configured to receive an indication from the driver of the vehicle to capture an image of the driver-relevant road scene information, wherein the indication comprises an oral command from the driver or button press by the driver indicating the driver-relevant road scene information.

20. The vehicle of claim 17, wherein the ECU is further configured to adjust navigation of the vehicle based on the driver-relevant road scene information.
